(19) United States
(12) Patent Application Publication
(10) Pub. No.: US 2003/0120570 A1
(43) Pub. Date: Jun. 26, 2003

(54) System and method for administering death benefits

(76) Inventors: Jeffrey K. Dellinger, Fort Wayne, IN (US); Ronald L. Stopher, Fort Wayne, IN (US); Denis G. Schwartz, Fort Wayne, IN (US); Lorry James Stensrud, Lake Forest, IL (US)

Correspondence Address: BARNES & THORNBURG, 600 One Summit Square, Fort Wayne, IN, 46802, US

(21) Appl. No.: 10/294,096

(22) Filed: Nov. 14, 2002

Related U.S. Application Data
(60) Provisional application No. 60/332,275, filed on Nov. 14, 2001.

(51) Int. Cl. G06F 17/60

(52) U.S. Cl. 705/35

(57) ABSTRACT

A computer method for administering a financial contract having a death benefit includes determining an initial amount of the death benefit and storing that amount, periodically determining and storing an adjusted amount of the benefit, and retrieving one of the amounts, and paying the retrieved amount to a beneficiary upon death of a contract holder. At least a portion of the initial or periodically adjusted amount is determined, at least in part, by reference to a factor external to the contract. The external factor may be a death benefit provided by a preexisting contract, a predetermined dollar amount, equity in a home or other asset, the dollar value of a specified asset, number of dependents of the contract holder, or a financial index. The adjusted benefit amount may vary with deposits and withdrawals by the contract holder. Also disclosed is a computer system for administering such a death benefit.

### RELATED APPLICATIONS

The present application is related to and claims priority to U.S. Provisional Patent Application, Serial No. 60/332,275, filed on Nov. 14, 2001, entitled System and Method for Administering Death Benefits. The subject matter disclosed in that provisional application is hereby expressly incorporated into the present application.

### FIELD OF INVENTION

This invention relates generally to financial services and products, and in particular to methods and systems for administering individual and group variable annuity contracts, both fixed and variable, and other financial vehicles, such as mutual funds. Specifically, this invention relates to methods and systems for administering death benefits relating to such contracts and instruments.

### BACKGROUND OF THE INVENTION

Variable annuities have for many years offered a variety of benefits that are considered incidental to the primary benefits provided by such annuities. Among these incidental benefits are various types of death benefits designed primarily for individual variable annuities.

Death benefits currently calculated and administered for individual annuities (and some mutual funds) include the following:

1. Account Value Death Benefits;

2. Return of Premium (or Deposit) Death Benefits;

3. High Water Mark Death Benefits (also known by other names);

4. Fixed Accumulation Death Benefits (also known by other names);

5. Tax Benefit Death Benefits for Non-qualified contracts; and

6. Tax Benefit Death Benefits for Qualified contracts.

These death benefits are described in additional detail below, and are illustrated in the table of FIG. 1 and graphically in FIGS. 2-7. It should be noted at the start that they all have one fact in common: the amount of the death benefit depends exclusively on values contained within the contract; i.e., the account value, premiums (also called deposits), withdrawals, and/or investment income (actual or hypothetical).

Each of the death benefits described in the following paragraphs may be subject to minimums and/or maximums established by the company, may vary by age, and may reflect withdrawals through a number of possible adjustments. The descriptions below are intended to convey a general understanding of how each type of death benefit is determined. Furthermore, some companies may combine one or more of the death benefit types in a single death benefit, or make some or all of the combinations of death benefit types available on a single annuity contract.

Account Value Death Benefits: Under this method of determining death benefits, the death benefit is always equal to the account value of the contract. Many annuity contracts have surrender charges associated with them and, for such contracts, the Account Value Death Benefit essentially waives the surrender charge and pays out the full account value at death, rather than the account value reduced by those surrender charges. Some annuities provide only the cash surrender benefit, so those that provide at least an Account Value Death Benefit are providing a modest additional benefit. The death benefit over time for a hypothetical, single-premium variable annuity having an initial value of $100,000 is illustrated by the vertical column labeled AV in the table of FIG. 1. The hypothetical death benefit of column AV of FIG. 1 is graphically illustrated in FIG. 2.

Return of Premium Death Benefits: This type of death benefit is slightly richer than Account Value Death Benefits and provides a death benefit equal to the greater of the amount of premiums (deposits) paid into the contract, reduced in some way by any withdrawals made from the contract, or the account value. On fixed annuity contracts, the Return of Premium Death Benefit is very similar to the Account Value Death Benefit. On variable annuity contracts, it provides a minimum death benefit that can be very valuable if investment returns are very negative. The death benefit over time for a hypothetical, single-premium variable annuity having an initial value of $100,000 is illustrated by the vertical column labeled ROP in the table of FIG. 1. FIG. 3 graphically illustrates the hypothetical death benefit of column ROP of FIG. 1, and contrasts that death benefit with the Account Value Death Benefit illustrated in FIG. 2.

High Water Mark Death Benefits: High Water Mark Death Benefits are very common on variable annuity contracts, since their value arises from a combination of good investment performance and volatility in that investment performance. High Water Mark Death Benefits operate somewhat like Return of Premium Death Benefits that periodically reset to higher and higher levels. Under a contract having a High Water Mark Death Benefit, the death benefit is equal to the greater of the account value on the date of death or the highest account value achieved on a contract anniversary prior to some maximum age established by the insurance company. Thus, if at the time of death the account value has fallen below the highest account value achieved on a prior anniversary, a death benefit equal to the prior highest account value is paid out. The highest anniversary account value is normally increased by premiums (deposits) made after it was achieved and reduced in some way by withdrawals made after it was achieved. The High Water Mark Death Benefit may also be set at frequencies other than the contract anniversary, e.g. monthly or quarterly. The death benefit over time for a hypothetical, single-premium $100,000 variable annuity is illustrated by the vertical column labeled HWM in the table of FIG. 1. FIG. 4 graphically illustrates the hypothetical death benefit of column HWM of FIG. 1, and contrasts that death benefit with the Account Value Death Benefit illustrated in FIG. 2.

Fixed Accumulation Death Benefit: Under this design, the death benefit is equal to premiums paid (deposits made) to the contract accumulated at a stated interest rate (e.g., 5%) from the time of payment until the date of death. Under this benefit, the beneficiary receives the greater of the account value (or some other death benefit), or the accumulation of premiums. The Fixed Accumulation Death Benefit is reduced in some way by withdrawals. The death benefit over time for a hypothetical, single-premium variable annuity having an initial value of $100,000 and a Fixed Accumulation Death Benefit which increases at 5% per year is illustrated by the vertical column labeled “5%” in the table of FIG. 1. FIG. 5 graphically illustrates the hypothetical death benefit of the “5%” column of FIG. 1, and contrasts that death benefit to the Account Value Death Benefit illustrated in FIG. 2.

Tax Benefit Death Benefit for Non-qualified Contracts: This death benefit generally pays an additional amount intended to help offset taxes payable by the beneficiary upon receipt of the contract proceeds on death of the owner. The typical death benefit is X% of the “gain” in the contract, where gain is defined as the excess of the account value at the time of death over the premiums/deposits paid into the contract. A maximum benefit typically applies. Withdrawals first reduce the gain in the contract and then premiums paid. The death benefit over time for a hypothetical, single-premium variable annuity having an initial value of $100,000 and a Tax Benefit Death Benefit for Non-qualified Contracts is illustrated by the vertical column labeled TAX-NQ in the table of FIG. 1. FIG. 6 graphically illustrates the hypothetical death benefit of column TAX-NQ of FIG. 1, and contrasts that death benefit to the Account Value Death Benefit illustrated in FIG. 2.

Tax Benefit Death Benefit for Qualified Contracts: Similar to the Tax Benefit Death Benefit for Non-qualified Contracts, the death benefit under this design is equal to some percentage of the entire account value, since the tax liability to the beneficiary is based on the entire account value. Because this death benefit is always equal to or greater than the account value, the death benefit may be arbitrarily limited in the first months or years of the contract to avoid the need to underwrite the benefit. The death benefit over time for a hypothetical, single-premium variable annuity having an initial value of $100,000 and a Tax Benefit Death Benefit for Qualified Contracts is illustrated by the vertical column labeled TAX-Q in the table of FIG. 1. FIG. 7 graphically illustrates the hypothetical death benefit of column TAX-Q of FIG. 1, and contrasts that death benefit to the Account Value Death Benefit illustrated in FIG. 2.

### SUMMARY OF THE INVENTION

One embodiment of the present invention comprises a computer method for administering a financial contract having a death benefit. This embodiment of the subject method includes the steps of determining an amount of the death benefit associated with the financial contract and storing the initial amount in a file, periodically determining an adjusted amount of the death benefit and storing the adjusted amount in the file, retrieving either the initial amount of the death benefit or the adjusted amount of the death benefit, and paying the retrieved amount to a beneficiary upon the death of a contract holder. In the subject method, at least a portion of either (or both) of the initial amount of the death benefit and the periodically adjusted amount of the death benefit is determined, at least in part, by reference to at least one factor which is external to the financial contract. The subject factor can be any of the following: a death benefit provided by a preexisting contract; a predetermined dollar amount; equity in a home or other asset; dollar value of a specified asset; the number of dependents of the contract holder; a financial index; or other equivalent or similar reference. In this and other embodiments, the step of periodically determining an adjusted amount of the death benefit may include at least one of the steps of adjusting the death benefit in response to deposits of additional premiums by the contract holder, and adjusting the amount of the death benefit in response to withdrawals by the contract holder.

In one embodiment of the subject method, the external factor is a death benefit of a preexisting contract. In this embodiment, the amount of the death benefit is determined, at least in part, by reference to the death benefit of the preexisting contract.

In another embodiment of the method, the external factor is a predetermined dollar amount. In this embodiment, the step of determining an initial amount of the death benefit includes the step of setting the initial death benefit equal to an account value, plus the predetermined dollar amount. In this embodiment, the step of periodically determining an adjusted amount of the death benefit includes the step of periodically adding the predetermined dollar amount to an adjusted account value. This embodiment may further comprise the step of adjusting the predetermined dollar amount in response to withdrawals by the contract holder.

In one embodiment of the method, the external factor is equity in a home or other asset. In this embodiment, the initial amount of the death benefit is determined, at least in part, by reference to the equity in a home or other asset.

In another embodiment of the subject method, the external factor is a dollar value of a specified asset. As in the other embodiments, the initial amount of the death benefit is determined, at least in part, by reference to the dollar value of the specified asset.

In one embodiment of the subject method, the external factor is a number of dependents of the contract holder, and as in the other embodiments, the initial amount of the death benefit is determined, at least in part, by reference to the number of dependents.

In another embodiment, the step of periodically determining an adjusted amount of the death benefit comprises at least one of the steps of indexing the initial amount of the death benefit to a financial index, and indexing an excess amount of the initial death benefit over an initial account value to a financial index. In one specific embodiment, the financial index is an inflation index, such as the Consumer Price Index. The financial index may also be an investment index, such as the Dow Jones Industrial Average. In some or all of these embodiments, the step of periodically determining an adjusted amount of the death benefit comprises at least one of the steps of adjusting the death benefit in response to deposits of additional premiums by the contract holder, and adjusting the amount of the death benefit in response to withdrawals by the contract holder.

In an alternative embodiment, the step of periodically determining an adjusted amount of the death benefit comprises the step of indexing at least a portion of the death benefit to a financial index. The financial index may be an inflation index, such as the Consumer Price Index, or an investment index, such as the Dow Jones Industrial Average, or other comparable indices. In certain of these embodiments, the step of periodically determining an adjusted amount of the death benefit comprises at least one of the steps of adjusting the death benefit in response to deposits of additional premiums by the contract holder and adjusting the amount of the death benefit in response to withdrawals by the contract holder.

In certain embodiments of the subject method, the adjusted amount of the death benefit is subject to either a maximum amount or a minimum amount, or both. Certain embodiments also include the additional steps of periodically generating a report, including at least the adjusted amount of the death benefit, and sending the report to the contract holder. Certain embodiments may also include the step of entering data relating to the financial contract for use in either (or both) of the steps of determining an initial amount of the death benefit and periodically determining an adjusted amount of the death benefit. The data entered include one or more of: a contract term; an initial premium; information relating to the contract holder; and information relating to the external factor used as a reference in determining the death benefit.

In addition to various embodiments of the subject method, the invention includes a computer system for administering a financial contract having a death benefit. The subject system may be constructed using conventional computing technology, including a processor, a memory or storage device, input and output devices, and one or more computer programs to implement the various steps and operations described above, and discussed below in connection with FIGS. 8-13.

Other advantages and novel features of the present invention will become apparent from the following detailed description of the invention when considered in conjunction with the accompanying drawings.

### BRIEF DESCRIPTION OF THE DRAWINGS

FIG. 1 is a table of values illustrating the death benefits over time for hypothetical, single-premium variable annuities having initial values of $100,000 and various types of prior art death benefits.

FIG. 2 graphically illustrates the death benefit over time for the column labeled AV in FIG. 1.

FIG. 3 graphically illustrates the death benefit over time for the column labeled ROP in FIG. 1.

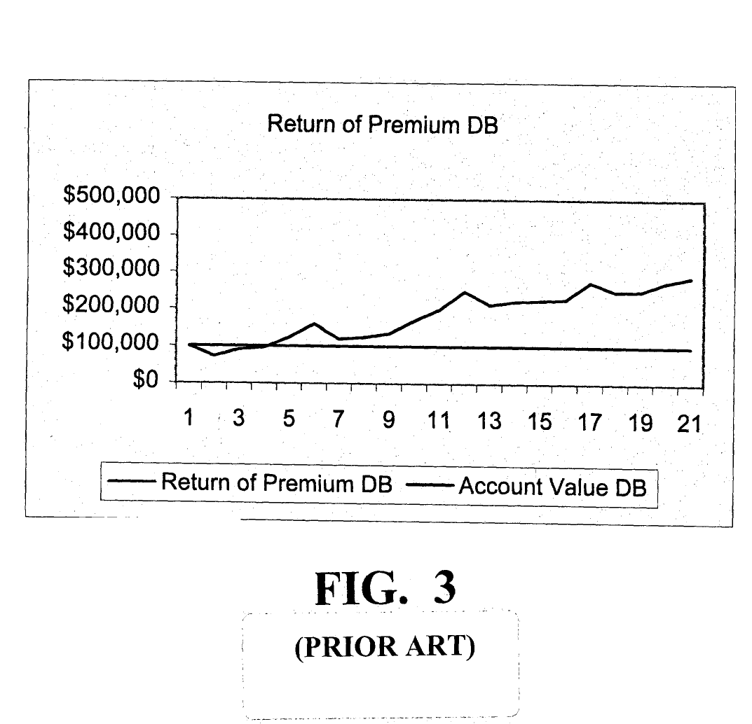

FIG. 4 graphically illustrates the death benefit over time for the column labeled HWM in FIG. 1.

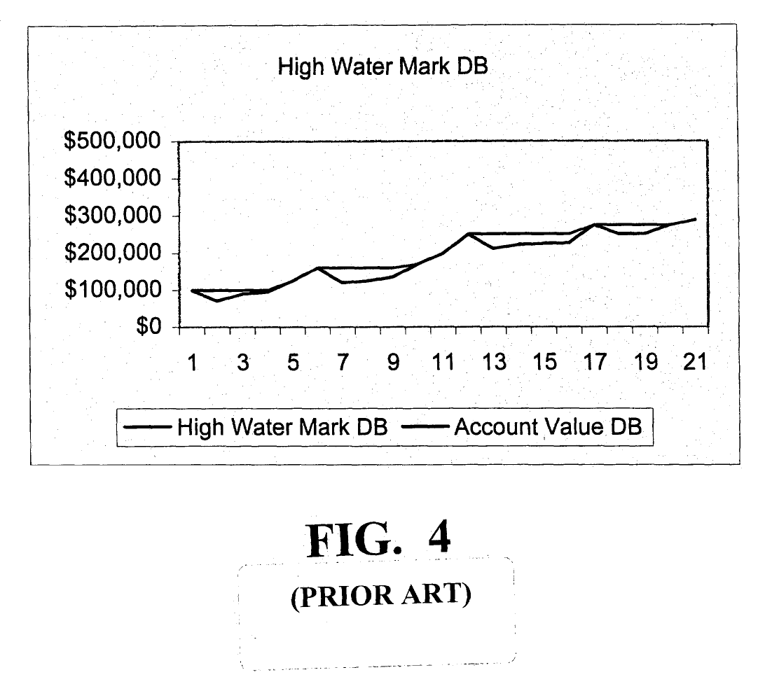

FIG. 5 graphically illustrates the death benefit over time for the column labeled 5% in FIG. 1.

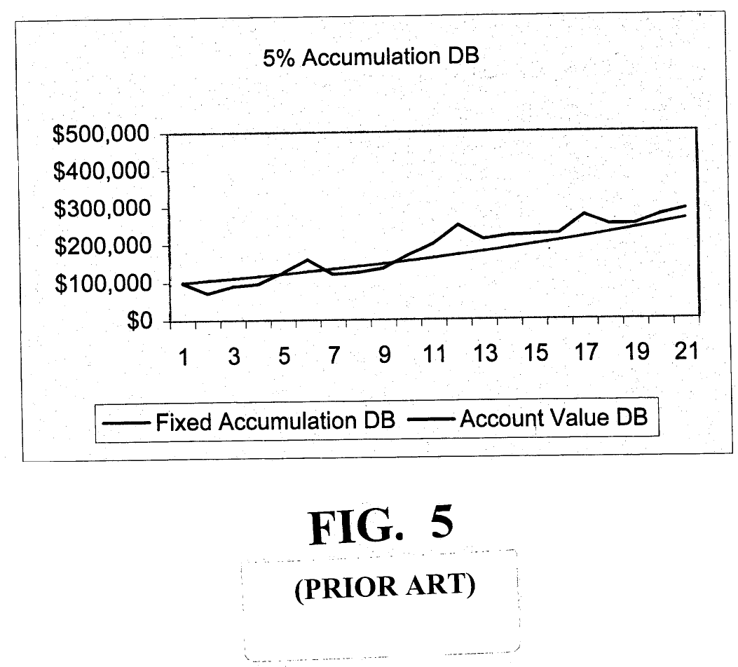

FIG. 6 graphically illustrates the death benefit over time for the column labeled TAX-NQ in FIG. 1.

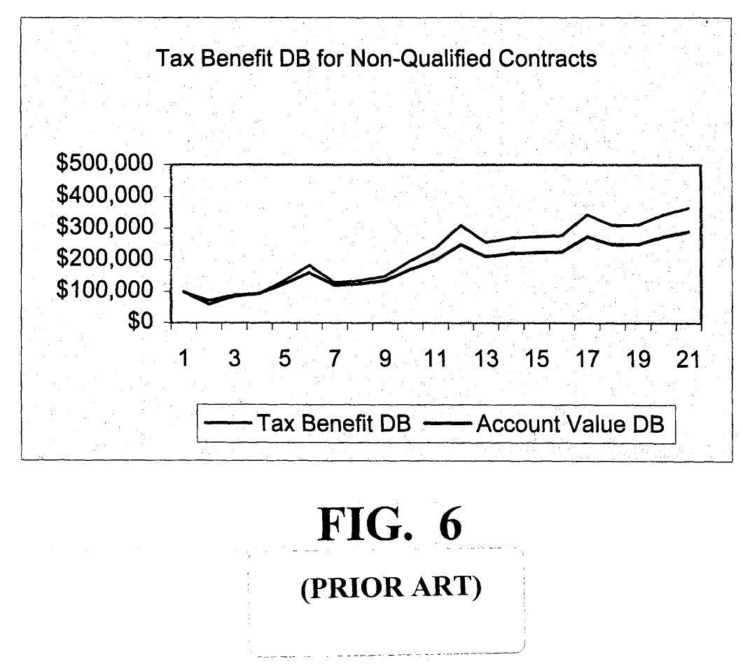

FIG. 7 graphically illustrates the death benefit over time for the column labeled TAX-Q in FIG. 1.

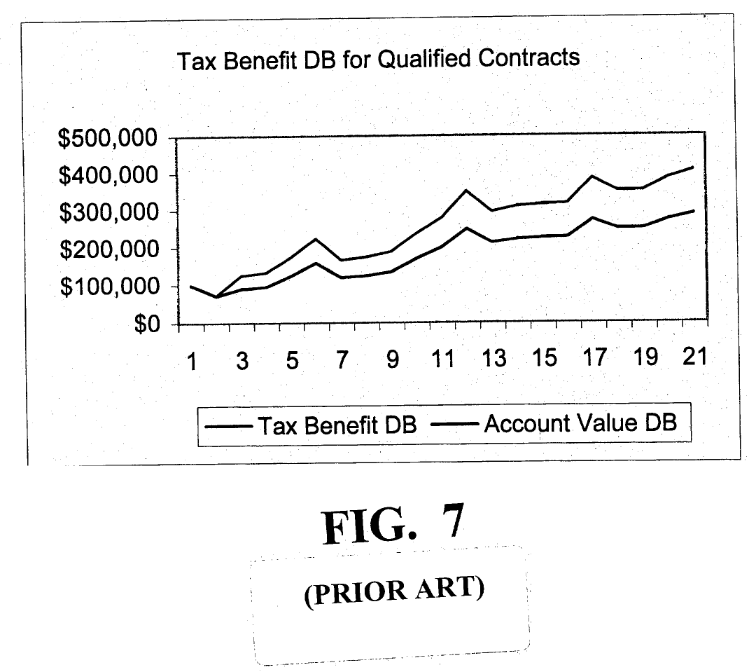

FIG. 8 is a table of values which illustrates the death benefits over time for hypothetical, single-premium variable annuities having initial values of $100,000 and death benefits determined in accordance with various embodiments of the present invention.

FIG. 9 graphically illustrates the death benefit over time for the column labeled EDB in FIG. 8.

FIG. 10 graphically illustrates the death benefit over time for the column labeled EXCESS in FIG. 8.

FIG. 11 graphically illustrates the death benefit over time for the column labeled CPI in FIG. 8.

FIG. 12 graphically illustrates the death benefit over time for the column labeled DJIA in FIG. 8.

FIG. 13 is a flow chart which further illustrates the operation of the method and system of the present invention.

### DETAILED DESCRIPTION

The present invention provides for the calculation and administration of a unique and new death benefit type. Unlike the existing individual annuity death benefits discussed above, which are based entirely on values within the contract itself, the new death benefit is based, at least in part, on one or more external (i.e., outside of the contract) factors, such as: an index (such as the Consumer Price Index or the Dow Jones Industrial Average); an asset (such as a prior annuity contract or real estate); a financial obligation (such as a loan); and a death benefit need (such as the number of dependents). While there may also be an interplay between the death benefit and internal factors (such as account value, premiums paid, withdrawals, etc.), the death benefit is always determined, at least in part, by one or more of the external factors. This invention introduces a new system for calculating and administering death benefits on individual and group annuities, whether variable or fixed. The invention also applies to mutual funds, retirement accounts, or other investment vehicles where these death benefits may be provided in a fashion similar to how they are provided for annuities.

The following examples illustrate how the invention can be embodied in a specific system and method to calculate death benefits:

1. Exchange Death Benefit;

2. Constant Excess Amount Death Benefit;

3. Inflation Indexed Death Benefit; and

4. Investment Indexed Death Benefit.

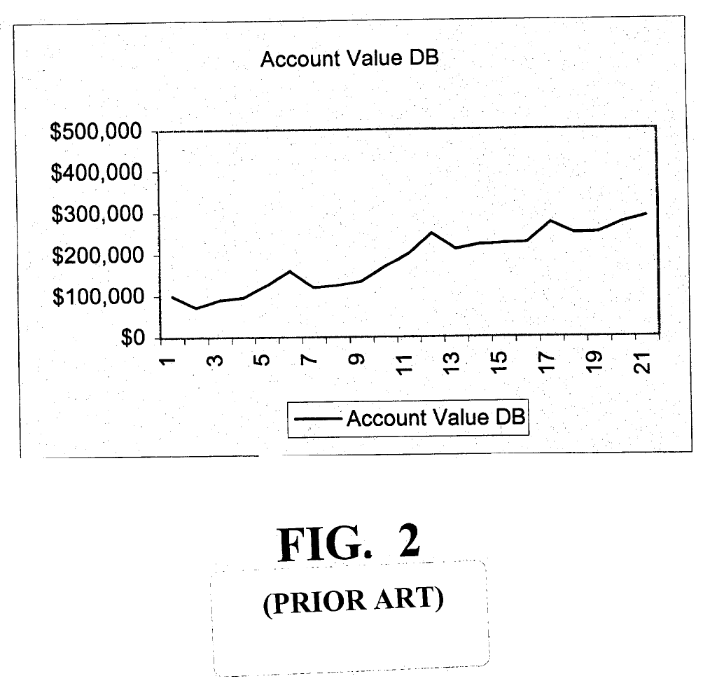

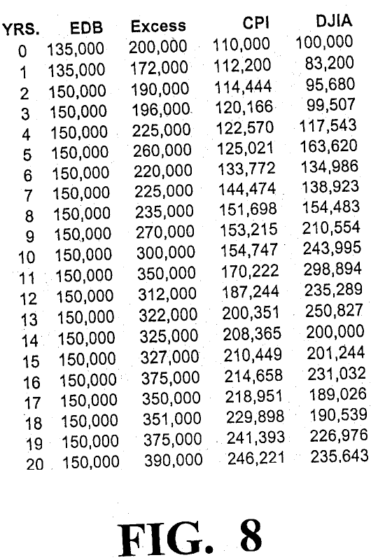

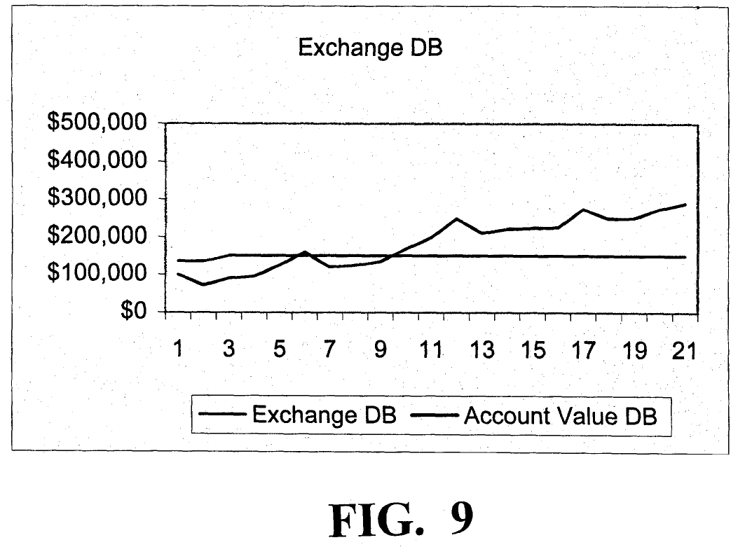

Exchange Death Benefit: This embodiment of the invention determines the death benefit by referencing the death benefit provided by a pre-existing contract that is being exchanged for a new contract. The pre-existing contract could be any type of contract that provides a death benefit, such as an annuity contract or a life insurance contract. Subsequent to the issuance of the new contract, this death benefit would typically be adjusted for premiums (deposits) and withdrawals made to the new contract. The death benefit over time for a hypothetical, single-premium variable annuity having an initial value of $100,000 is illustrated in the column labeled EDB in the table of FIG. 8. In this example, the death benefit is set by reference to an existing death benefit on a preexisting contract (which is being exchanged) having a death benefit of $150,000. The death benefit in the first 2 years of the new contract is reduced by $15,000 to offset, at least partially, the costs associated with setting the death benefit by reference to the preexisting contract. Other periods of reduced benefit, and other amounts of reduction, could be used. FIG. 9 graphically illustrates the hypothetical death benefit of column EDB, and contrasts that death benefit to the Account Value Death Benefit graphically illustrated in FIG. 2.

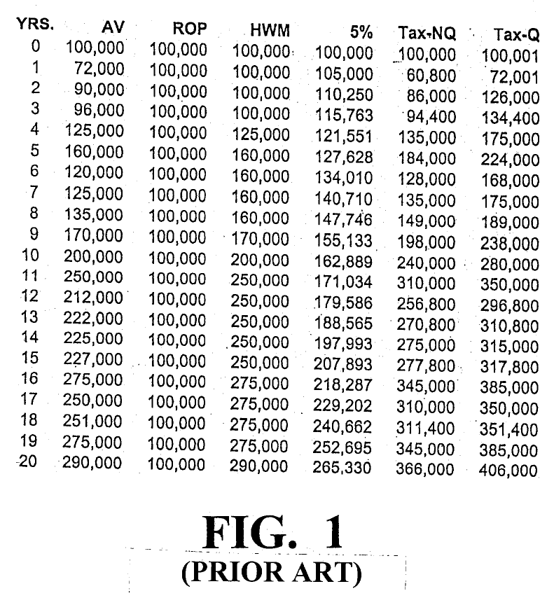

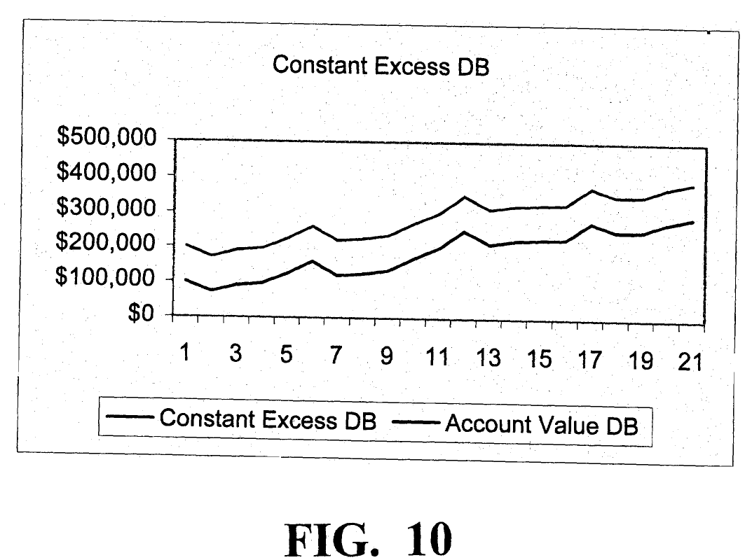

Constant Excess Amount Death Benefit: The embodiment provides a death benefit equal to the account value plus a constant excess amount (e.g., $100,000). The excess amount is determined, at least in part, by reference to an external factor, such as equity in a home or other asset, number of dependents of the contract holder, or other factors. Significantly, and similarly to the Exchange Death Benefit, the Constant Excess Amount Death Benefit is determined at issue by reference to something outside the contract. The death benefit will then vary over time as the account value varies since the excess amount initially determined at issue is constant. The excess amount could, however, be reduced in some way by withdrawals. The hypothetical death benefit over time for a single-premium variable annuity having an initial value of $100,000 and a Constant Excess Amount Death Benefit is illustrated by the column labeled EXCESS in the table of FIG. 8. In this example, the excess amount is determined at issue (by reference to an external factor such as one of those noted above) to be $100,000. The amounts in the column labeled EXCESS in the table of FIG. 8 thus exceed the amounts in the column labeled AV in the table of FIG. 1 by $100,000 for each of the years listed. FIG. 10 graphically illustrates the hypothetical death benefit of column EXCESS of FIG. 8, and contrasts that death benefit to the death benefit illustrated in FIG. 2.

Inflation Indexed Death Benefit: In this embodiment, the death benefit is calculated by reference to an inflation index, such as the Consumer Price Index. The amount indexed may be the entire death benefit amount, or the excess of the initial death benefit over the initial account value. The initial death benefit is established at issue in any of several ways (including those described in this document), but after issue the death benefit is adjusted to reflect movement in the chosen inflation index.

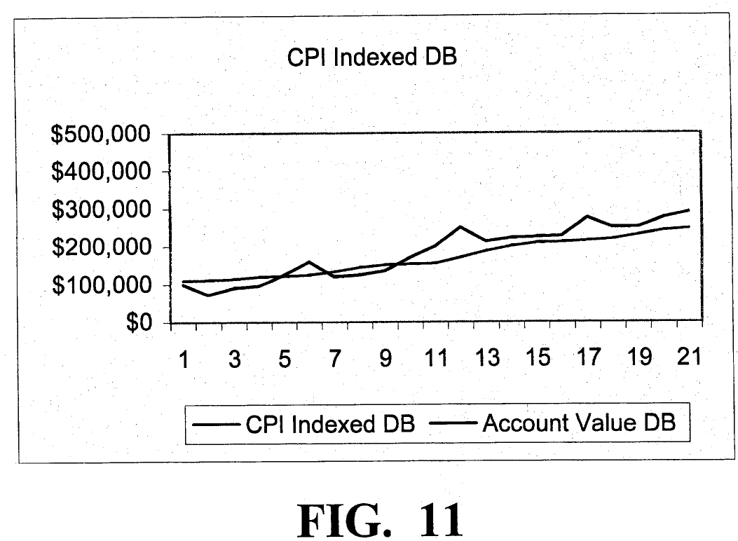

The hypothetical death benefit over time for a single-premium variable annuity having an initial value of $100,000 and an Inflation Indexed Death Benefit is illustrated in the vertical column labeled CPI of FIG. 8. The initial death benefit, in this case $110,000, is set by reference to an asset (for example, home equity). That is, the excess over the $100,000 premium (in this case $10,000) is equal to or in some way related to existing equity in an asset, such as a home. The value of the death benefit over time is then indexed to, for example, the Consumer Price Index. Other indices could be used, such as an index related to the increase in housing costs. As indicated, the amount indexed could be the entire death benefit amount, or just the excess of the initial death benefit over the initial account value. FIG. 11 graphically illustrates the hypothetical death benefit of column CPI of FIG. 8, and contrasts that death benefit to the Account Value Death Benefit illustrated in FIG. 2.

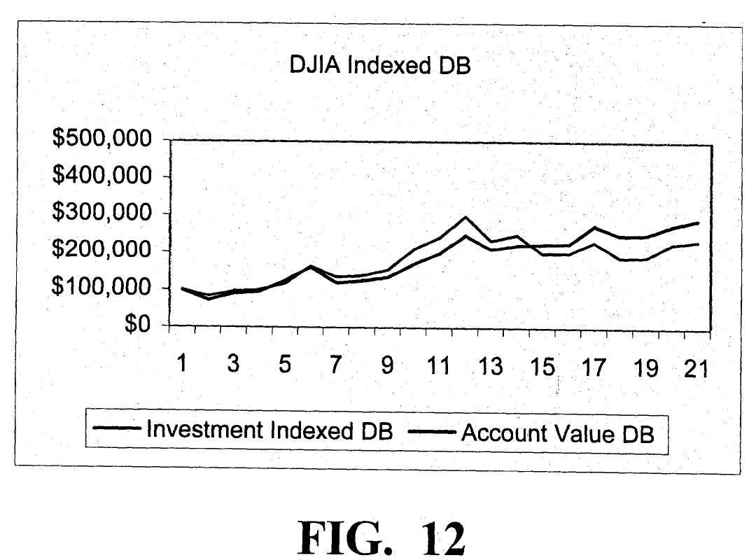

Investment Indexed Death Benefit: Similar to the Inflation Indexed Death Benefit, the death benefit calculated by this embodiment is indexed to some investment index outside of the contract, such as the Dow Jones Industrial Average (“DJIA”). The hypothetical death benefit over time for a single-premium variable annuity having an initial value of $100,000 and a death benefit which is indexed to an investment index, such as the DJIA, is illustrated by the vertical column labeled DJIA in the table of FIG. 8. In this illustration, the initial death benefit is set equal to the initial account value, and then indexed according to changes in the hypothetical investment index. As in the preceding discussions, the initial death benefit could be set by reference to some other asset in addition to the account value, such as home equity. FIG. 12 graphically illustrates the hypothetical death benefit of column DJIA of FIG. 8, and contrasts that death benefit to the Account Value Death Benefit illustrated in FIG. 2.

In each of these examples, the system must have information outside of the annuity contract (or mutual fund contract) in order to determine the death benefit. That information may be needed only at the inception of the contract, or may be needed periodically throughout the life of the contract.

While this list of death benefits calculated and administered under the invention is not exhaustive, these death benefits are all determined or affected at one time or another by factors outside of the contract providing the current death benefit. These death benefits may have maximums and/or minimums and may be adjusted by values or events within the contract (such as additional premium payments or withdrawals or investment events). The invention could be applicable to death benefits provided by individual and/or group annuities, mutual funds, bank accounts, or other individually-owned or group-owned financial accounts.

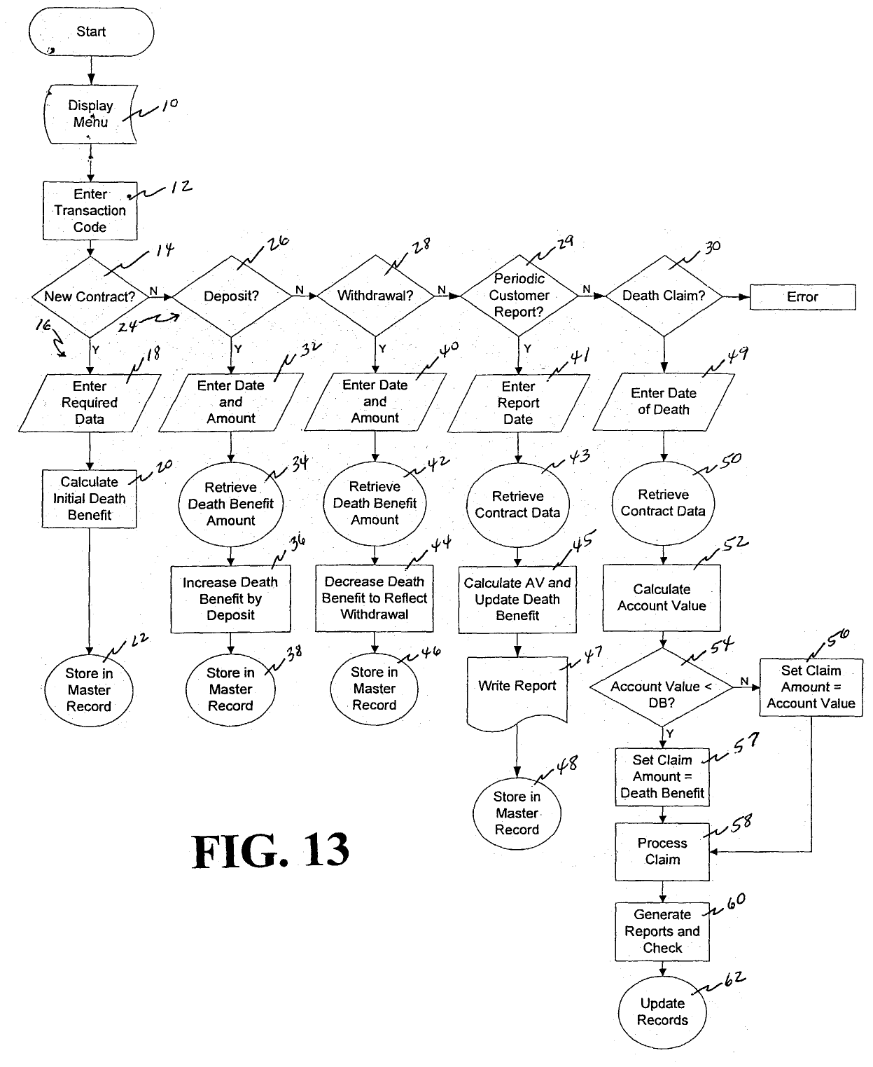

FIG. 13 is a flow chart which illustrates a computerized method of administering a contract, such as an annuity or mutual fund contract, having a death benefit which is determined in accordance with the present invention. The first operation in the embodiment illustrated by FIG. 13 is the display of a menu, represented by block 10 in FIG. 13. After selecting the appropriate item from the menu, provision may be made for entry of a transaction code (12) which may be used as an identifier or in an access control capacity. The system then inquires as to whether the subject transaction relates to a new or existing contract (14). If the transaction relates to a new contract, program flow follows branch 16, generally indicated by the arrow in FIG. 13.

The first step in branch 16 is the entry of required data concerning the new contract. This operation is represented generally by block 18. Such information includes, for example, the contract term, initial premium, information regarding the contract holder, and other information typically associated with such contracts. Such information also includes data required to determine the death benefit (for example, the death benefit on a pre-existing contract).

After entry of required information, the system calculates an initial death benefit for a particular embodiment of the invention (20). For example, if the contract specifies an Exchange Death Benefit, information will have been entered regarding the death benefit of the pre-existing contract. That information will then be used by the system to calculate the initial death benefit under the new contract. The results of the calculation are stored (22) in a master record, along with other information relating to the new contract.

If the contract to which the transaction relates is not a new contract (i.e., the transaction relates to a contract previously entered into which incorporates the invention), flow proceeds from block 14 in the direction indicated by arrow 24. The system then determines whether the transaction is a deposit (26), a withdrawal (28), a periodic customer report (29), or a death claim (30). If the transaction is a deposit, the system allows for entry of the date and amount of the deposit (32). The amount of the existing death benefit is then retrieved (34) and the death benefit is updated (i.e., increased) in accordance with the contract terms (36). The updated death benefit is then stored in the master record (38).

If the transaction in question is a withdrawal, a similar process ensues. That is, the date and amount of the withdrawal are entered into the system (40). The existing death benefit is then retrieved from the master record (42), and the death benefit is updated (i.e., decreased) to reflect the effects of the withdrawal in accordance with the contract terms (44). The updated death benefit is then stored in the master record (46).

If the transaction in question is a periodic customer report, the system requests entry of the report date (41). The system then retrieves the contract data (43), and then calculates the account value and updates the death benefit (45) in accordance with the contract terms. The system then generates a report (47) which may be forwarded to the customer. Information relating to the report is then stored in the master record (48).

If the transaction is a death claim, the system requests entry of the date of death (49). The system then retrieves the contract data (50) and calculates the current account value (52). The system then determines whether the account value is an amount less than the death benefit (54). If not, the claim amount is set equal to the account value (56) and the claim is processed for payment (58). If the account value is less than the current death benefit, the claim amount is set equal to the death benefit (57) and processing of the claim proceeds. In either event, a check or other funds transfer is effected and, if desired, a report is generated (60). The records in the system are then updated appropriately (62).

What is claimed is:

1. A computer method for administering a financial contract having a death benefit, comprising the steps of:
a) determining an initial amount of the death benefit associated with the financial contract and storing the initial amount in a file;
b) periodically determining an adjusted amount of the death benefit and storing the adjusted amount in the file; and
c) retrieving one of the initial amount of the death benefit and the adjusted amount of the death benefit, and paying the retrieved amount to a beneficiary upon the death of a contract holder;
d) wherein, at least a portion of at least one of the initial amount of the death benefit and the periodically adjusted amount of the death benefit is determined, at least in part, by reference to at least one factor external to the financial contract.

2. The method of claim 1, wherein said at least one factor is chosen from a group which includes at least the following: a death benefit provided by a preexisting contract; a predetermined dollar amount; equity in a home or other asset; dollar value of a specified asset; number of dependents of the contract holder; a financial index.

3. The method of claim 2, wherein the step of periodically determining an adjusted amount of the death benefit comprises at least one of the steps of adjusting the death benefit in response to deposits of additional premiums by the contract holder and adjusting the amount of the death benefit in response to withdrawals by the contract holder.

4. The method of claim 1, wherein said at least one factor is a death benefit of a preexisting contract, and wherein the initial amount of the death benefit is determined, at least in part, by reference to said death benefit of a preexisting contract.

5. The method of claim 1, wherein said at least one factor is a predetermined dollar amount, and wherein the step of determining an initial amount of the death benefit includes the step of setting the initial death benefit equal to an account value plus said predetermined dollar amount.

6. The method of claim 5, wherein the step of periodically determining an adjusted amount of the death benefit comprises the step of periodically adding the predetermined dollar amount to an adjusted account value.

7. The method of claim 6, further comprising the step of adjusting the predetermined dollar amount in response to withdrawals by the contract holder.

8. The method of claim 1, wherein said at least one factor is equity in a home or other asset, and wherein the initial amount of the death benefit is determined, at least in part, by reference to said equity in a home or other asset.

9. The method of claim 1, wherein said at least one factor is a dollar value of a specified asset, and wherein the initial amount of the death benefit is determined, at least in part, by reference to said dollar value of a specified asset.

10. The method of claim 1, wherein said at least one factor is a number of dependents of the contract holder, and wherein the initial amount of the death benefit is determined at least in part, by reference to said number of dependents of contract holder.

11. The method of claim 1, wherein the step of periodically determining an adjusted amount of the death benefit comprises at least one of the steps of indexing the initial amount of the death benefit to a financial index, and indexing an excess amount of the initial death benefit over an initial account value to a financial index.

12. The method of claim 11, wherein the financial index is an inflation index, such as the Consumer Price Index.

13. The method of claim 11, wherein the financial index is an investment index, such as the Dow Jones Industrial Average.

14. The method of claim 13, wherein the step of periodically determining an adjusted amount of the death benefit comprises at least one of the steps of adjusting the death benefit in response to deposits of additional premiums by the contract holder and adjusting the amount of the death benefit in response to withdrawals by the contract holder.

15. The method of claim 1, wherein the step of periodically determining an adjusted amount of the death benefit comprises the step of indexing at least a portion of the death benefit to a financial index.

16. The method of claim 15, wherein the financial index is at least one of an inflation index, such as the Consumer Price Index, and an investment index, such as the Dow Jones Industrial Average.

17. The method of claim 15, wherein the step of periodically determining an adjusted amount of the death benefit comprises at least one of the steps of adjusting the death benefit in response to deposits of additional premiums by the contract holder and adjusting the amount of the death benefit in response to withdrawals by the contract holder.

18. The method of claim 1, wherein the adjusted amount of the death benefit is subject to at least one of a maximum amount and a minimum amount.

19. The method of claim 1, comprising the additional steps of periodically generating a report, including at least the adjusted amount of the death benefit, and sending the report to the contract holder.

20. The method of claim 1, further comprising the step of entering data relating to the financial contract for use in at least one of the steps of determining an initial amount of the death benefit and periodically determining an adjusted amount of the death benefit, said data including one or more of: a contract term; an initial premium; information relating to the contract holder; and information relating to said at least one factor external to the financial contract.

21. A computer system for administering a financial contract having a death benefit, comprising:
a) means for determining an initial amount of the death benefit associated with the financial contract and for storing the initial amount in a file;
b) means for periodically determining an adjusted amount of the death benefit and for storing the adjusted amount in the file; and
c) means for retrieving one of the initial amount of the death benefit and the adjusted amount of the death benefit, and for paying the retrieved amount to a beneficiary upon the death of a contract holder;
d) wherein, at least a portion of at least one of the initial amount of the death benefit and the periodically adjusted amount of the death benefit is determined, at least in part, by reference to at least one factor external to the financial contract.

22. The system of claim 21, wherein said at least one factor is chosen from a group which includes at least the following: a death benefit provided by a preexisting contract; a predetermined dollar amount; equity in a home or other asset; dollar value of a specified asset; number of dependents of the contract holder; a financial index.

23. The system of claim 22, wherein the means for periodically determining an adjusted amount of the death benefit comprises at least one of means for adjusting the death benefit in response to deposits of additional premiums by the contract holder, and means for adjusting the amount of the death benefit in response to withdrawals by the contract holder.

24. The system of claim 21, wherein said at least one factor is a death benefit of a preexisting contract, and wherein the initial amount of the death benefit is determined, at least in part, by reference to said death benefit of a preexisting contract.

25. The system of claim 21, wherein said at least one factor is a predetermined dollar amount, and wherein the means for determining an initial amount of the death benefit includes means for setting the initial death benefit equal to an account value plus said predetermined dollar amount.

26. The system of claim 25, wherein the means for periodically determining an adjusted amount of the death benefit comprises means for periodically adding the predetermined dollar amount to an adjusted account value.

27. The system of claim 26, further comprising means for adjusting the predetermined dollar amount in response to withdrawals by the contract holder.

28. The system of claim 21, wherein said at least one factor is equity in a home or other asset, and wherein the initial amount of the death benefit is determined, at least in part, by reference to said equity in a home or other asset.

29. The system of claim 21, wherein said at least one factor is a dollar value of a specified asset, and wherein the initial amount of the death benefit is determined, at least in part, by reference to said dollar value of a specified asset.

30. The system of claim 21, wherein said at least one factor is a number of dependents of the contract holder, and wherein the initial amount of the death benefit is determined at least in part, by reference to said number of dependents of contract holder.

31. The system of claim 21, wherein the means for periodically determining an adjusted amount of the death benefit comprises at least one of means for indexing the initial amount of the death benefit to a financial index, and means for indexing an excess amount of the initial death benefit over an initial account value to a financial index.

32. The system of claim 31, wherein the financial index is an inflation index, such as the Consumer Price Index.

33. The system of claim 31, wherein the financial index is an investment index, such as the Dow Jones Industrial Average.

34. The system of claim 33, wherein the means for periodically determining an adjusted amount of the death benefit comprises at least one of means for adjusting the death benefit in response to deposits of additional premiums by the contract holder, and means for adjusting the amount of the death benefit in response to withdrawals by the contract holder.

35. The system of claim 21, wherein the means for periodically determining an adjusted amount of the death benefit comprises means for indexing at least a portion of the death benefit to a financial index.

36. The system of claim 35, wherein the financial index is at least one of an inflation index, such as the Consumer Price Index, and an investment index, such as the Dow Jones Industrial Average.

37. The system of claim 35, wherein the means for periodically determining an adjusted amount of the death benefit comprises at least one of means for adjusting the death benefit in response to deposits of additional premiums by the contract holder, and means for adjusting the amount of the death benefit in response to withdrawals by the contract holder.

38. The system of claim 21, wherein the adjusted amount of the death benefit is subject to at least one of a maximum amount and a minimum amount.

39. The system of claim 21, further comprising means for periodically generating a report, including at least the adjusted amount of the death benefit, and for sending the report to the contract holder.

40. The system of claim 21, further comprising means for entering data relating to the financial contract for use by at least one of the means for determining an initial amount of the death benefit and for periodically determining an adjusted amount of the death benefit, said data including one or more of: a contract term; an initial premium; information relating to the contract holder; and information relating to said at least one factor external to the financial contract.
